(19) United States
(12) Patent Application Publication
(10) Pub. No.: US 2023/0202482 A1
(43) Pub. Date: Jun. 29, 2023

(54) VEHICLE CONTROL DEVICE, OPERATION METHOD OF VEHICLE CONTROL DEVICE, AND STORAGE MEDIUM

(71) Applicant: HONDA MOTOR CO., LTD., Tokyo (JP)

(72) Inventors: Hironobu KIRYU, Wako-shi (JP); Takuya TOBE, Wako-shi (JP)

(21) Appl. No.: 17/982,608

(22) Filed: Nov. 8, 2022

(30) Foreign Application Priority Data
Dec. 28, 2021 (JP) 2021-215065

(51) Int. Cl. B60W 30/18; B60W 50/14

(52) U.S. Cl. CPC B60W 30/18163; B60W 50/14; B60W 2552/10; B60W 2520/10

(57) ABSTRACT

A vehicle control device that controls a vehicle, the vehicle control device comprising: an acquisition unit configured to acquire surrounding information of the vehicle; and a control unit configured to conduct an automated lane change based on the surrounding information, wherein the control unit changes a setting of either a duration needed for the automated lane change or a travel distance needed for the automated lane change, based on either an instruction from a user or position information of the vehicle at a time of conducting the automated lane change.

### CROSS-REFERENCE TO RELATED APPLICATION(S)

This application claims priority to and the benefit of Japanese Patent Application No. 2021-215065 filed on Dec. 28, 2021, the entire disclosure of which is incorporated herein by reference.

### BACKGROUND OF THE INVENTION

### Field of the Invention

The present invention relates to a vehicle control device, an operation method of the vehicle control device, and a storage medium.

### Description of the Related Art

As a technology of automated driving, automated lane change control is known (Japanese Patent Laid-Open No. 2018-092538).

However, laws and regulations required for the automated lane change control differ depending on the nation or the state. For example, a duration and a travel distance that have to be taken in conducting the automated lane change differ depending on the nation or the state, in some cases. For this reason, it is difficult to comply with the laws and regulations of the respective nations or states with one fixed product specification. In particular, in a case of moving across the nations or the states, there is a possibility that the specification does not comply with the laws and regulations in a movement destination.

The present invention has been made in recognition of the above issue as an opportunity, and provides a technique for easily changing a setting related to the automated lane change to an appropriate setting and improving traffic safety.

### SUMMARY OF THE INVENTION

According to one aspect of the present invention, there is provided a vehicle control device that controls a vehicle, the vehicle control device comprising: an acquisition unit configured to acquire surrounding information of the vehicle; and a control unit configured to conduct an automated lane change based on the surrounding information, wherein the control unit changes a setting of either a duration needed for the automated lane change or a travel distance needed for the automated lane change, based on either an instruction from a user or position information of the vehicle at a time of conducting the automated lane change.

### BRIEF DESCRIPTION OF THE DRAWINGS

The accompanying drawings illustrating embodiments in the present invention constitute a part of the specification, and are used together with the description to describe the present invention;

FIG. 1 is a diagram for describing a configuration example of a vehicle according to an embodiment;

FIG. 2 is a block diagram for describing a configuration example of the vehicle according to an embodiment;

FIG. 3 is a diagram for describing an automated lane change operation according to an embodiment;

FIG. 4 is a diagram illustrating an example of a lane change requirement in the respective states in the United States;

FIG. 5 is a flowchart for describing an example of a procedure of processing performed by a vehicle control device according to a first embodiment; and

FIG. 6 is a flowchart for describing an example of a procedure of processing performed by a vehicle control device according to a second embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

<Vehicle Configuration>

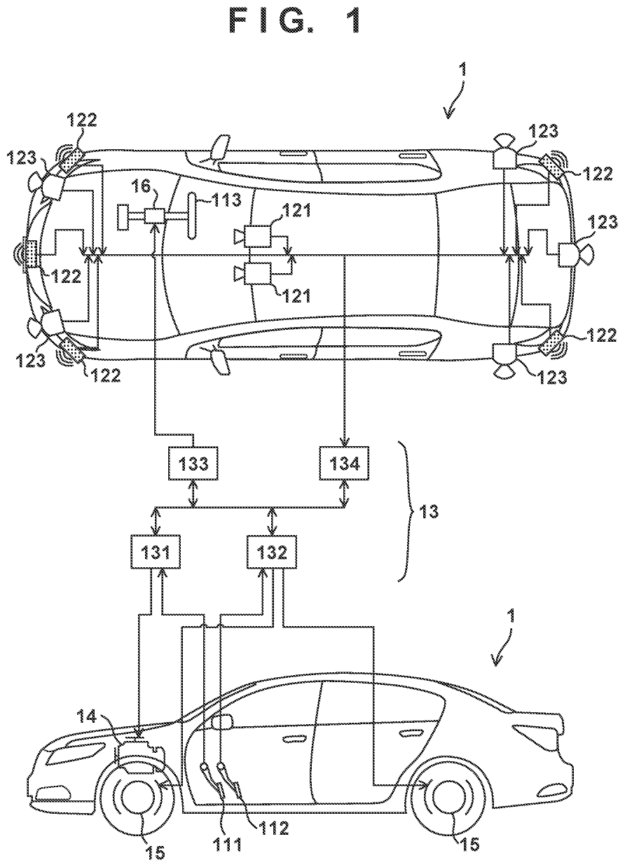

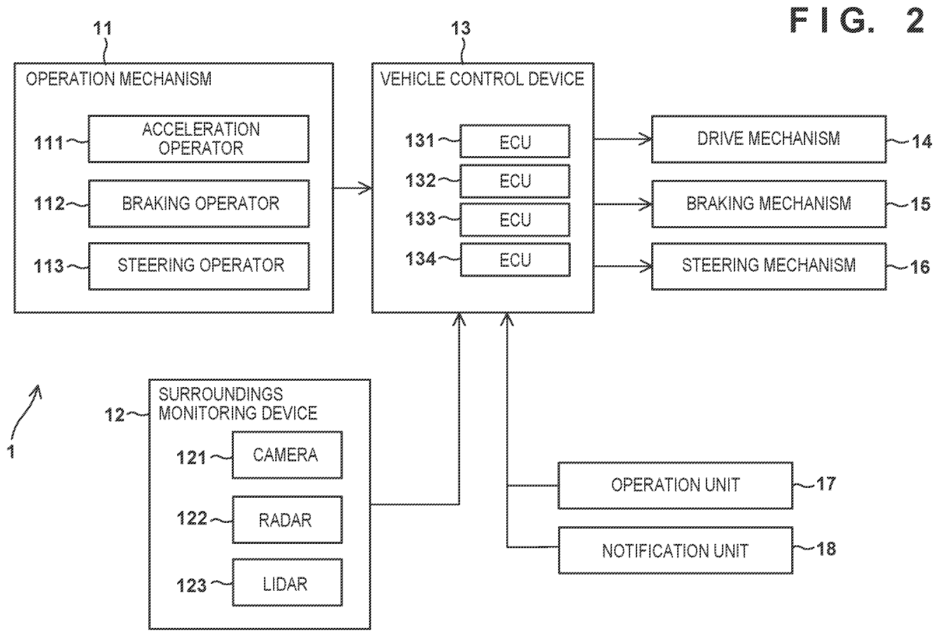

FIGS. 1 and 2 are diagrams for describing a configuration of a vehicle 1 according to a first embodiment. FIG. 1 illustrates arrangement positions of the respective elements to be described below and a connection relationship between the elements, by using a top view and a side view of the vehicle 1. FIG. 2 is a system block diagram of the vehicle 1.

Note that in the following description, expressions such as front/rear, up/down, and lateral sides (left/right) will be used, in some cases, as expressions indicating relative directions indicated with respect to a vehicle body of the vehicle 1 as a reference. For example, the term “front” indicates the front side of the vehicle body as seen in a front-and-rear direction, and the term “upper” indicates a height direction of the vehicle body.

The vehicle 1 includes an operation mechanism 11, a surroundings monitoring device 12, a vehicle control device 13, a drive mechanism 14, a braking mechanism 15, and a steering mechanism 16. In the present embodiment, the vehicle 1 is a four-wheeled vehicle, but the number of wheels is not limited to this.

The operation mechanism 11 includes an acceleration operator 111, a braking operator 112, and a steering operator 113. Typically, the acceleration operator 111 is an accelerator pedal, the braking operator 112 is a brake pedal, and the steering operator 113 is a steering wheel. However, for these operators 111 to 113, any other type such as a lever type or a button type may be used.

The surroundings monitoring device 12 includes a camera 121, a radar 122, and a light detection and ranging (LiDAR) 123, all of which function as sensors for monitoring or detecting surrounding environments of the vehicle (self-vehicle) 1. The camera 121 is an imaging device including, for example, a charge-coupled device (CCD) image sensor, a complementary metal oxide semiconductor (CMOS) image sensor, or the like. The radar 122 is, for example, a ranging device such as a millimeter wave radar. The LiDAR 123 is, for example, a ranging device such as a laser radar. As illustrated in FIG. 1, these components are disposed at positions where the surrounding environments of the vehicle 1 can be detected, for example, on the front side, the rear side, the upper side, and the lateral sides of the vehicle body.

Examples of the surrounding environment of the vehicle 1 described above include a travel environment of the vehicle 1 and an environment in the surroundings of the vehicle 1 related thereto (extending direction of lanes, adjacent lanes, travelable areas, colors of traffic signals, and the like), and object information in the surroundings of the vehicle 1 (presence or absence of objects such as other vehicles, pedestrians, and obstacles, and attributes and positions, directions and speeds in the movement of the objects, and the like). From this viewpoint, the surroundings monitoring device 12 may be expressed as a detection device or the like for detecting and acquiring the surrounding information of the vehicle 1.

The vehicle control device 13 is capable of controlling the vehicle 1, and controls the respective mechanisms 14 to 16, based on signals from the operation mechanism 11 and/or the surroundings monitoring device 12, for example. The vehicle control device 13 includes a plurality of electronic control units (ECUs) 131 to 134. Each ECU includes one or more CPUs, one or more memories, and one or more communication interfaces. Each ECU performs predetermined processing by the CPU, based on information (data or electric signal) received via the communication interface, and stores the processing results in the memory or outputs the processing results to another element via the communication interface.

The ECU 131 is an acceleration ECU, and controls the drive mechanism 14, to be described later, based on, for example, an operation amount of the acceleration operator 111 by the driver. The ECU 132 is a braking ECU, and controls the braking mechanism 15 based on, for example, an operation amount of the braking operator 112 by the driver. The braking mechanism 15 is, for example, a disc brake provided on each wheel. The ECU 133 is a steering ECU, and controls the steering mechanism 16 based on, for example, an operation amount of the steering operator 113 by the driver. The steering mechanism 16 includes, for example, power steering.

The ECU 134 is an analysis ECU provided to correspond to the surroundings monitoring device 12. The ECU 134 performs a predetermined analysis/process, based on the surrounding environment of the vehicle 1 that has been obtained by the surroundings monitoring device 12, and outputs results to the ECUs 131 to 133.

That is, the ECUs 131 to 133 are capable of controlling the respective mechanisms 14 to 16, based on signals from the ECU 134. According to this configuration, the vehicle control device 13 is capable of conducting travel control of the vehicle 1 in accordance with a surrounding environment and conducting automated driving, for example.

In addition, the ECU 134 controls the vehicle 1, based on a user operation on the vehicle 1 via an operation unit 17, acquires position information of the vehicle 1, and controls the vehicle 1, based on the position information that has been acquired. Furthermore, the ECU 134 controls a notification unit 18 to notify the user of various types of information. The operation unit 17 can include various physical switches and a direction-indicator lever (direction-indicator switch), a touch panel, or the like provided in the vehicle. The notification unit 18 is capable of notifying various types of information using a display screen of the navigation device, voice, light, or the like. The position information of the vehicle 1 may be identified by use of global positioning system (GPS), global navigation satellite system (GNSS), or global navigation satellite system (GLONASS), or may be identified by collating map information included in the vehicle 1 with imaging information of the camera 121. Alternatively, the position information may be identified by receiving communication from a public institution. In addition, a rough position may be identified by simply analyzing a road sign that has been captured by the camera 121.

Herein, the automated driving means that some or all of the driving operations (acceleration, braking, and steering) are not performed by the driver, but are performed by the vehicle control device 13. That is, the concept of the automated driving includes a mode in which all of the driving operations are performed by the vehicle control device 13 (so-called fully automated driving) and a mode in which only some of the driving operations are performed by the vehicle control device 13 (so-called driving assistance). Examples of the driving assistance include a vehicle speed control (automatic cruise control) function, an inter-vehicle distance control (adaptive cruise control) function, a lane departure prevention assist (lane keeping assist) function, a collision prevention assist function, and the like.

Note that the vehicle control device 13 is not limited to the present configuration. For example, a semiconductor device such as an application specific integrated circuit (ASIC) may be used for each of the ECUs 131 to 134. That is, the functions of the respective ECUs 131 to 134 are achievable by any of hardware and software. In addition, some or all of the ECUs 131 to 134 may be configured with a single ECU.

<Automated Lane Change>

The vehicle control device 13 is capable of conducting a plurality of types of automated lane change control including first lane change control and second lane change control. The first lane change control is, for example, automated lane change control to be started from a system, that is, control in which the vehicle control device 13 makes a lane change, based on self-determination by use of the surroundings information. The second lane change control is, for example, automated lane change control to be started from a vehicle occupant (driver), and is control in which the vehicle occupant (driver) gives an instruction (for example, a direction-indicator lever operation or a direction-indicator switch operation) as a starting point, and an automated lane change is made by the vehicle control device 13.

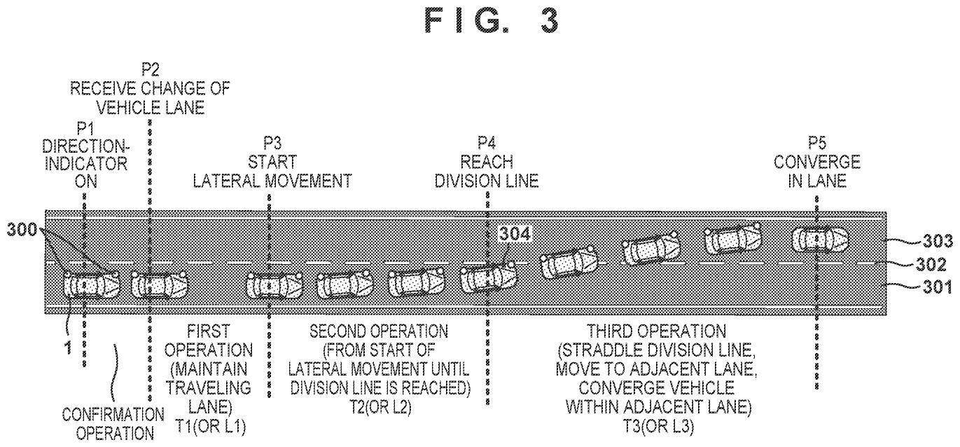

Next, an example of the automated lane change according to the present embodiment will be described with reference to FIG. 3. In FIG. 3, the vehicle 1 is traveling in a traveling lane 301, and makes a lane change to an adjacent lane 303 across a division line 302 (for example, a white line) that divides the traveling lane 301 from the adjacent lane 303. The automated lane change here is, for example, an automated lane change based on an instruction from a user. The instruction from the user is, for example, an operation instruction to input a direction to which the user desires to make a lane change by operating the direction-indicator lever (direction-indicator switch). A period from the time when the direction-indicator operation is performed to the time when the receipt of the automated lane change is completed differs for every vehicle. That is, such a period is determined in accordance with the system performance, a different period is needed for every vehicle. When a direction-indicator operation is performed at P1, a direction-indicator 300 starts blinking. A confirmation operation for confirming the instruction from the user is performed within a period from the time when the direction-indicator operation is performed at P1 to the time when the automated lane change is received at P2.

Then, after the automated lane change is received at P2, a first operation of maintaining the vehicle 1 in the traveling lane is performed. To be specific, straight travel in the traveling lane 301 is continued, until a duration T1 elapses or until the vehicle travels a travel distance L1.

When the duration T1 has elapsed or when the vehicle has traveled the travel distance L1, the vehicle starts a lateral movement at P3. The lateral movement mentioned here means that the ECU 134 controls the steering mechanism 16 to move the vehicle 1 toward the direction of the adjacent lane 303. That is, after the first operation, a second operation is performed from the time when the lateral movement is started at P3 to the time when the vehicle reaches the division line 302 at P4. To be specific, the lateral movement is continued until a duration T2 elapses or until the vehicle travels a travel distance L2. In other words, the operation from P3 to P4 is performed taking the duration T2. Alternatively, the operation from P3 to P4 is performed while the vehicle is traveling the travel distance L2.

Whether the vehicle 1 has reached the division line 302 is determined, based on whether a reference position of the vehicle 1 has reached the division line 302. The reference position can be set to any position of the vehicle 1, and can be set to, for example, a front wheel position 304 of the vehicle 1 in a direction of the lateral movement. In addition, the reference position may be set to any position on the center line of the vehicle 1 in the front-and-rear direction. In the example of FIG. 3, the reference position is set to the position of the left front wheel of the vehicle 1.

Furthermore, after having reached the division line 302 at P4, the vehicle 1 continues the lateral movement, moves to the adjacent lane 303 across the division line 302, and performs a third operation of causing the vehicle 1 to converge in the adjacent lane 303 at P5. To be specific, a series of operations from P4 to P5 are continued until a duration T3 elapses or until the vehicle travels a travel distance L3. In other words, the operation from P4 to P5 is performed taking the duration T3. Alternatively, the operation from P4 to P5 is performed while traveling the travel distance L3. Then, after a predetermined time (for example, 0.5 seconds) has elapsed since the vehicle traveled across the division line 302 (since the right rear wheel traveled over the division line 302 in the example of FIG. 3), the direction-indicator 300 is turned off. At P5, the direction-indicator 300 converges in the lane, and the direction-indicator 300 is turned off.

In this manner, a series of automated lane change operations are performed. Note that the durations T1, T2, and T3 may be longer depending on the surrounding information. Similarly, the travel distances L1, L2, and L3 may be longer. For example, there is also a conceivable case where another vehicle is traveling in the adjacent lane 303 and the lane change operation cannot be performed smoothly. In such a case, T1, T2, and T3 may be longer than initial setting values. The respective operations may be performed by taking at least T1, T2, and T3. Similarly, L1, L2, and L3 may be distances longer than initial setting values. It is sufficient if the vehicle 1 travels at least L1, L2, and L3.

Here, UN-R79, which is an agreement of United Nations (UN) regulations with regard to steering equipment. In R79-03 of the UN regulations, it is specified that the driving straight ahead has to be maintained for at least one second as a period from the time when receipt of the automated lane change is decided at P2 to the time when the lateral movement is started at P3. In the nations that have ratified UN-R79, the duration T1 from P2 to P3 is set as a fixed value of one second. Alternatively, a predetermined period longer than one second may be set including a margin. Note that the travel distance may be specified, instead of the duration, the travel distance L1 from P2 to P3 may be set as a predetermined fixed value. On the other hand, in the nations that have not ratified UN-R79, the duration T1 is set to an optional value that is customizable by the user. Alternatively, the travel distance L1 is set to an optional value that is customizable by the user.

Since the duration T2 from P3 to P4 is a period in compliance with the laws and regulations of each nation, the duration T2 is set to an optional value that is customizable by the user in the nations that have ratified UN-R79 and the other nations that have not ratified UN-R79. Alternatively, the travel distance L2 from P3 to P4 is set to an optional value that is customizable by the user.

Examples of the customization method may include a method for allowing the user to directly input a numerical value, or a method for allowing the user to freely select a value from a plurality of options so that the value that has been selected by the user can be set. As an example, in the nations that have not ratified UN-R79, the duration T1 may be set to a value to be selected by the user from options such as 0.3 seconds, 0.6 seconds, 1.0 seconds, and the like. In addition, also in the nations that have ratified UN-R79, the duration T2 may be set to a value to be selected by the user from options such as 2.0 seconds, 2.5 seconds, 3.0 seconds, and the like. Furthermore, the duration T3 or the travel distance L3 from P4 to P5 may also be set to an optional value that is customizable by the user.

<Requirements in the Respective States in the United States>

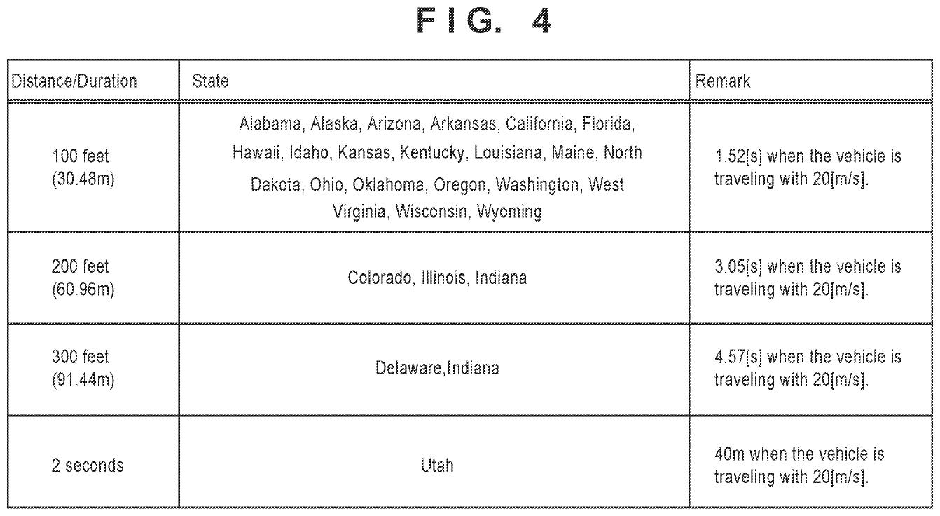

Subsequently, FIG. 4 is a diagram illustrating examples of a lane change requirement in the respective states in the United States. In the United States, different states require different conditions. In Alabama, etc., the travel distance L2 from P3 to P4 requires 100 feet (30.48 meters). This corresponds to 1.52 seconds being required as the duration T2, while a vehicle is traveling at a vehicle speed of 20 m/s. In Colorado, etc., the travel distance L2 from P3 to P4 requires 200 feet (60.96 meters). This corresponds to 3.05 seconds being required as the duration T2, while a vehicle is traveling at a vehicle speed of 20 m/s.

In Delaware, etc., the travel distance L2 from P3 to P4 requires 300 feet (91.44 meters). This corresponds to 4.57 seconds being required as the duration T2, while a vehicle is traveling at a vehicle speed of 20 m/s. In Utah, the duration T2 from P3 to P4 requires two seconds. This corresponds to 40 meters being required as the travel distance L2, while a vehicle is traveling at a vehicle speed of 20 m/s.

<Processing>

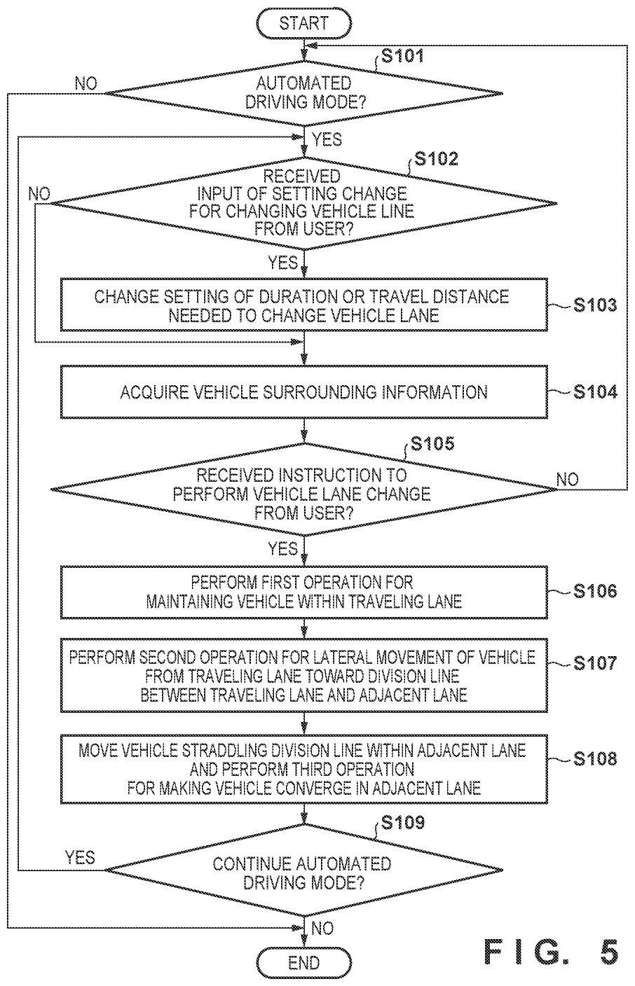

Next, a procedure of processing performed by the vehicle control device according to the present embodiment will be described with reference to a flowchart of FIG. 5.

First, in step S101 (hereinafter, simply referred to as “S101”. The same applies to other steps), the vehicle control device 13 determines whether the operation mode of the vehicle 1 is the automated driving mode. In a case where the operation mode is the automated driving mode, the processing proceeds to S102, and in the other cases (in a case where the operation mode is the normal mode in which the driver performs all the driving operations), this flow ends. Note that switching between the normal mode and the automated driving mode as the operation mode of the vehicle 1 can be conducted by a driver (alternatively, a person who can be a driver when the automated driving is canceled) pushing a predetermined switch in the vehicle.

In S102, the vehicle control device 13 determines whether an input for changing the setting of the automated lane change has been received from the user. This process is performed to determine whether, for example, the user has operated a physical switch or a display screen such as a navigation screen provided in the vehicle 1 to display a screen for changing the setting of the automated lane change, and the user has operated the screen and set at least one value of the durations T1 to T3 or at least one value of the travel distances L1 to L3. The method for customizing the durations T1 to T3 or the travel distances L1 to L3 may be a method for directly inputting a numerical value or a method for selecting by the user from a plurality of options that have been registered beforehand. Directly inputting a numerical value can be performed by, for example, an operation of changing the numerical value in accordance with the rotation of a dial switch or the like and deciding the value with a desired value. Alternatively, in a case where the display screen is something like a touch panel, a numerical value may be directly input by a touch panel operation. The customization can be done while the vehicle is traveling. In a case where this step is Yes, the processing proceeds to S103. On the other hand, in a case where this step is No, the processing proceeds to S104.

In S103, by reflecting the setting value received in S102, the vehicle control device 13 changes the setting of at least one of the durations T1 to T3 or the travel distances L1 to L3 needed for the automated lane change.

In S104, the vehicle control device 13 acquires surrounding information of the vehicle 1. This step is performed by the ECU 134 of the vehicle control device 13 acquiring the surrounding information of the vehicle 1 that has been detected by the surroundings monitoring device 12. The vehicle control device 13 controls the operations (acceleration, braking, and/or steering) of the vehicle 1, based on the surrounding information.

In S105, the vehicle control device 13 determines whether an instruction to conduct the automated lane change has been received from the user. The instruction to conduct the automated lane change is determined, based on, for example, whether the operation on the direction-indicator lever has been received. In a case where the instruction to conduct the automated lane change has been received, the processing proceeds to S106. On the other hand, in a case where the instruction to conduct the automated lane change has not been received, the processing returns to S101.

In S106, the vehicle control device 13 performs the first operation of maintaining the vehicle 1 in the traveling lane, based on the surrounding information of the vehicle 1. This operation corresponds to the operation from P2 to P3 illustrated in FIG. 3. In this situation, the operation is performed by use of either the duration T1 or the travel distance L1, which has been already set in the vehicle 1. That is, the operation is performed by taking the duration T1, or the operation is performed by traveling the travel distance L1.

In S107, the vehicle control device 13 performs the second operation of causing the vehicle 1 to make a lateral movement from the traveling lane toward a division line between the traveling lane and its adjacent lane. This operation corresponds to the operation from P3 to P4 illustrated in FIG. 3. In this situation, the operation is performed by use of either the duration T2 or the travel distance L2, which has been already set in the vehicle 1. That is, the operation is performed by taking the duration T2, or the operation is performed by traveling the travel distance L2.

In S108, the vehicle control device 13 performs the third operation of moving the vehicle 1 across the division line into the adjacent lane and causing the vehicle 1 to converge in the adjacent lane. This operation corresponds to the operation from P4 to P5 illustrated in FIG. 3. In this situation, the operation is performed by use of either the duration T3 or the travel distance L3, which has been already set in the vehicle 1. That is, the operation is performed by taking the duration T3, or the operation is performed by traveling the travel distance L3.

In S109, the vehicle control device 13 determines whether the operation mode of the vehicle 1 continues the automated driving mode. In a case where the automated driving mode is continued, the processing returns to S102, and in a case where the automated driving mode is not continued, this flow ends. Heretofore, a series of processes of FIG. 5 ends.

As described above, in the present embodiment, either the duration or the travel distance on each stage (for example, P2 to P3, P3 to P4, and/or P4 to P5) of the automated lane change is configured to be freely customizable by the user. Then, the operation for the automated lane change is performed by use of the setting value that has been designated by the user.

Accordingly, the automated lane change in compliance with the requirements of each nation or each state can be achieved, and the compliance can be improved. Furthermore, for example, in a case where a user has moved from a nation X to a nation Y respectively having different requirements, or moves from a state A to a state B respectively having different requirements, the user changes the setting and is able to conduct the automated lane change in compliance with the state or the nation that is a movement destination.

[Modifications]

In the present embodiment, the description has been given for an example in which either the duration or the travel distance on each stage in the automated lane change is freely customizable by the user. In this situation, for example, the position information of the vehicle 1 may be acquired from GPS or the like, and whether the current setting value satisfies the legal requirements of the automated lane change in the nation or the state where the vehicle 1 is currently traveling may be determined, based on the position information that has been acquired. Then, in a case where it is determined that the requirements are not satisfied, the notification unit 18 may present a warning to the user. The warning may be presented, for example, by voice, or on a display unit (not illustrated) of a navigation screen, a meter unit, or the like provided in the vehicle 1. The content of the warning can be a text message or a voice message indicating that the current setting value does not satisfy the requirements for the automated lane change in the current nation or state. The user is able to recognize the current situation by receiving the warning, and the user is able to quickly display a customization screen of the duration or the travel distance and change the value to an appropriate one.

In addition, the current setting value may be notified to the user by display or voice before customization. In the case of display, for example, the current setting value can be displayed in a specific display area of the meter unit in front of the driver's seat, or can be displayed on the navigation screen. In a case where the legal requirements are not satisfied before the customization, but are satisfied after the customization, a text message or a voice message such as “the legal requirements are satisfied” may be notified.

In addition, it is sufficient if the durations T1 to T3 or the travel distances L1 to L3 on the respective stages mean taking times or traveling the distances equal to or longer than these values. Therefore, in the respective operations of the automated lane change, the periods equal to or longer than these setting values may be taken, or the distances equal to or longer than these setting values may be traveled.

Furthermore, the description has been given for an example of defining the necessary duration or travel distance by respectively dividing the stages. However, a plurality of stages may be collectively defined, and one duration or one travel distance may be defined for the plurality of stages. For example, in the nations that have not ratified UN-R79, the durations T1 and T2 may be designated collectively by one setting value. Similarly, in the nations that have not ratified UN-R79, the travel distances L1 and L2 may be designated collectively by one setting value.

Further, in a case where the user inputs an instruction to change the setting of the duration or the travel distance, a pop-up screen for confirming an intention to change the setting may be displayed. For example, a confirmation screen such as “Change Setting? Yes/No” may be displayed, and when Yes is selected, the setting change may be received.

### Second Embodiment

In the first embodiment, the description has been given for an example in which the duration or the travel distance on each stage in the automated lane change is configured to be customizable by the user performing an operation input by himself/herself. On the other hand, in the present embodiment, a description will be given for an example in which the setting value related to the automated lane change is automatically changed to a setting value in compliance with the laws and regulations of the nation or the state where the vehicle 1 is present.

Note that a device configuration and the like are similar to those of the first embodiment, and thus detailed descriptions thereof will be omitted. In the example of FIG. 3 in the first embodiment, the description has been given for the flow of the automated lane change from the operation of the direction-indicator lever by the user as a starting point. However, in the present embodiment, the automated lane change is started by the system. The operation contents in the first operation of P2 to P3, the second operation of P3 to P4, and the third operation of P4 to P5 are similar to those in the first embodiment. However, in the case of the automated lane change to be started from the system, the confirmation operation within the period from P1 to P2 illustrated in FIG. 3 is not essential, and the confirmation operation within the period from P1 to P2 may be eliminated. On the other hand, before starting the operation of P2 and later, an inquiry about whether to conduct the automated lane change to be started from the system may be made for the user, and the first operation of P2 to P3 may be started in response to an instruction for the start that has been input by the user.

<Processing>

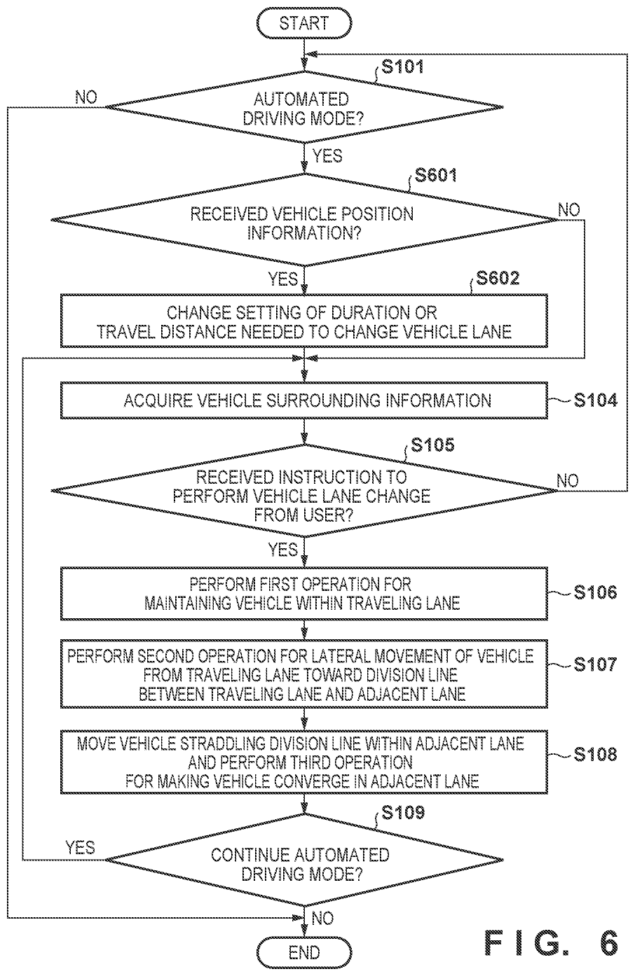

Next, a procedure of processing performed by the vehicle control device according to the present embodiment will be described with reference to a flowchart of FIG. 6. Similarly to the flowchart of FIG. 5, the same reference numerals are given to the same processes, and the descriptions thereof will be omitted. In the following, differences from FIG. 5 will be mainly described.

In S601, the vehicle control device 13 determines whether the position information of the vehicle 1 has been received. The position information can be acquired by use of, for example, GPS. In a case where this step is Yes, the processing proceeds to S602. On the other hand, in a case where this step is No, the processing proceeds to S104.

In S602, the vehicle control device 13 changes the setting of the duration or the travel distance needed for the automated lane change, based on the position information of the vehicle 1. For example, a table that specifies the legal requirements of every nation or every state is held beforehand, and the setting value is automatically changed to a setting value that satisfies the legal requirements. In a case where the vehicle 1 is located is a nation that has ratified UN-R79, for example, the value of the duration T1 may be automatically changed to a fixed value of one second. In addition, the value of the duration T2 may be automatically changed to any one of a plurality of options. In such a situation, in a case where there are a plurality of options, the standard value may be set. For example, in a case where the options of the duration T2 are 2.0 seconds, 2.5 seconds, and 3.0 seconds, 2.5 seconds may be automatically selected. For the duration T3, processing similar to that for the duration T2 may be performed.

Note that the description has been given for the duration as an example, similar processing can be performed in a case where the travel distance is specified. That is, while the travel distance L1 is set to a predetermined fixed value, the travel distances L2 and L3 may be automatically determined to standard values among a plurality of options.

The other steps are the same as those in the first embodiment. However, in a case of No in S601 and the processing proceeds to S104, the setting of the duration or the travel distance needed for the automated lane change is not changed, and thus the processing is performed by use of the current setting.

As described heretofore, in the present embodiment, the vehicle control device 13 automatically changes the setting value related to the automated lane change to the setting value in compliance with the laws and regulations of the nation or the state where the vehicle 1 is present, based on the position information of the vehicle 1.

Accordingly, even in a case where the vehicle 1 has moved to a nation or a state with different laws and regulations while traveling, the setting value can be automatically changed to a setting value in compliance with the nation or the state of the movement destination without bothering the user, and the convenience of the user can be improved.

[Modifications]

In the present embodiment, the description has been given for an example in which the setting value related to the automated lane change is automatically changed to the setting value in compliance with the laws and regulations of the nation or the state where the vehicle 1 is present, based on the position information of the vehicle 1. However, since an optional value (standard value) that satisfies the legal requirements is automatically set, there is a conceivable case where the user desires to change the setting value to another setting value that satisfies the legal requirements in accordance with the user's preference. Hence, after the setting is automatically changed, at least some setting values may be customizable by the user. The customization method may be a method similar to the method that has been described in the first embodiment. Thus, the convenience of the user can be further improved.

In each of the above embodiments, in a case where the traveling speed of the vehicle is a low speed equal to or lower than a predetermined speed (for example, an optional value such as 40 km/h or 50 km/h), the automated lane change may be conducted based on the setting of the travel distance needed for the automated lane change, instead of the setting of the duration needed for the automated lane change. Accordingly, in the case of the automated lane change while the vehicle is traveling at a low speed, a sufficient travel distance cannot be ensured by determining with the duration, in some cases. However, even in such cases, an operation in compliance with the regulations related to the travel distance can be performed.

### Other Embodiments

In addition, a vehicle control program for implementing one or more functions that have been described in each of the embodiments is supplied to a system or an apparatus through a network or a storage medium, and one or more processors in a computer of the system or the apparatus are capable of reading and executing the program. The present invention is also achievable by such an aspect.

[Summary of Embodiments]

Configuration 1. The vehicle control device in the above embodiment is

a vehicle control device (for example, 13, 134) that controls a vehicle (for example, 1), the vehicle control device including:

an acquisition unit (for example, 12, 134) configured to acquire surrounding information of the vehicle; and

a control unit configured to conduct an automated lane change based on the surrounding information, in which

the control unit changes a setting of either a duration (for example, T1 to T3) needed for the automated lane change or a travel distance (for example, L1 to L3) needed for the automated lane change, based on either an instruction from a user or position information of the vehicle at a time of conducting the automated lane change.

With this configuration, the user is able to freely change the setting related to the automated lane change or to change the setting related to the automated lane change in accordance with a geographical location of the vehicle. That is, it becomes easily possible to change the setting related to the automated lane change to an appropriate setting. Therefore, it becomes possible to easily change the setting to a setting in compliance with the laws and regulations related to the automated lane change that differs depending on the nation or the state, the compliance at the time of traveling can be improved, and the traffic safety can be improved. In addition, with one product specification, it becomes possible to comply with the laws and regulations in all nations or states, and thus the merchantability can be improved.

Configuration 2. In the vehicle control device in the above embodiment,

an operation for the automated lane change includes a first operation (for example, P2 to P3) of maintaining the vehicle in a traveling lane (for example, 301).

This configuration enables a change in the setting of either the duration (for example, T1) or the travel distance (for example, L1) needed for the operation of maintaining the vehicle in the traveling lane to be conducted at the time of the automated lane change.

Configuration 3. In the vehicle control device in the above embodiment,

the control unit changes a setting of either a duration needed for the first operation or a travel distance needed for the first operation.

This configuration easily enables a change in either the duration (for example, T1) or the travel distance (for example, L1) needed for the operation of maintaining the vehicle in the traveling lane to an appropriate setting.

Configuration 4. In the vehicle control device in the above embodiment,

the operation for the automated lane change further includes a second operation (for example, P3 to P4) of causing the vehicle to make a lateral movement until the vehicle reaches a division line (for example, 302) between the traveling lane and an adjacent lane (for example, 303), after the first operation.

This configuration enables a change in the setting of either the duration (for example, T2) or the travel distance (for example, L2) needed for the operation of the lateral movement toward the division line, subsequently to the operation of maintaining the vehicle in the traveling lane performed at the time of conducting the automated lane change.

Configuration 5. In the vehicle control device in the above embodiment,

the second operation is an operation from the vehicle starting the lateral movement to a reference position (for example, 304) of the vehicle reaching the division line.

With this configuration, it becomes possible to clearly determine whether the vehicle has reached the division line.

Configuration 6. In the vehicle control device in the above embodiment,

the reference position is a front wheel position (for example, 304) of the vehicle in a direction of the lateral movement.

Accordingly, since it is sufficient if whether the front wheel position of the vehicle has reached the division line, it becomes possible to clearly determine whether the vehicle has reached the division line.

Configuration 7. In the vehicle control device in the above embodiment,

the control unit changes a setting of either a duration (for example, T2) needed for the second operation or a travel distance (for example, L2) needed for the second operation.

This configuration easily enables a change in either the duration (for example, T2) or the travel distance (for example, L2) needed for the operation of the lateral movement toward the division line to an appropriate setting.

Configuration 8. In the vehicle control device in the above embodiment,

the operation for the automated lane change further includes a third operation (for example, P4 to P5) of causing the vehicle to travel across the division line and converge in the adjacent lane, after the second operation.

This configuration enables a change in the setting of either the duration (for example, T3) or the travel distance (for example, L3) needed for the operation to cause the vehicle to converge in the adjacent lane across the division line, subsequently to the operation of the lateral movement toward the division line performed at the time of conducting the automated lane change.

Configuration 9. In the vehicle control device in the above embodiment,

the control unit changes a setting of either a duration (for example, T3) needed for the third operation or a travel distance (for example, L3) needed for the third operation.

This configuration easily enables a change in either the duration (for example, T3) or the travel distance (for example, L3) needed for the operation of causing the vehicle to travel across the division line and converge in the adjacent lane to an appropriate setting.

Configuration 10. The vehicle control device in the above embodiment

further includes a reception unit (for example, 17) configured to receive the instruction from the user, in which

the control unit changes the setting of either the duration or the travel distance, based on the instruction received by the reception unit.

This configuration enables the user to freely change the setting related to the automated lane change.

Configuration 11. In the vehicle control device in the above embodiment,

a plurality of candidates are registered beforehand for the duration or the travel distance, and

the user selects any of the plurality of candidates, and the control unit changes the setting of either the duration or the travel distance.

This configuration eliminates the need for the user to directly designate a numerical value, and thereby improves user convenience.

Configuration 12. The vehicle control device in the above embodiment,

further includes a confirmation unit (for example, 134) configured to prompt confirmation of a change in the setting (for example, display of a pop-up screen), when the instruction from the user is received.

This configuration gives an opportunity to avoid a change in the setting that does not meet the user's intention.

Configuration 13. The vehicle control device in the above embodiment

further includes a position information acquisition unit (for example, GPS, 134) configured to acquire the position information of the vehicle, in which

when the vehicle moves into a different nation or state, based on the position information of the vehicle, the control unit changes the setting of either the duration or the travel distance to a setting in compliance with the different nation or state.

Accordingly, even when the user does not realize it, it becomes possible to automatically change the setting related to the automated lane change to an appropriate setting in accordance with the location of the vehicle, and thus the convenience of the user is improved.

Configuration 14. The vehicle control device in the above embodiment further includes

a position information acquisition unit (for example, GPS, 134) configured to acquire the position information of the vehicle; and

a notification unit (for example, 134, 18) configured to notify a warning, in a case where the setting of either the duration or the travel distance is not appropriate for a nation, a state, or a province where the vehicle is traveling, based on the position information of the vehicle.

With this configuration, the user is able to easily recognize that the setting related to the automated lane change is not an appropriate value.

Configuration 15. In the vehicle control device in the above embodiment,

an operation for the automated lane change includes

a first operation (for example, P2 to P3) of maintaining the vehicle in a traveling lane, and

a second operation (for example, P3 to P4) of causing the vehicle to make a lateral movement until the vehicle reaches a division line between the traveling lane and an adjacent lane, after the first operation, and

the control unit

does not change, as a fixed value, a setting of either a duration (for example, T1) needed for the first operation or a travel distance (for example, L1) needed for the first operation (for example, the duration is set to a fixed value of one second), and

changes a setting of either a duration (for example, T2) needed for the second operation or a travel distance (for example, L2) needed for the second operation.

Accordingly, for example, it becomes possible to increase the degree of freedom in changing the setting, while the setting complies with the requirements of the automated lane change in the nations that have ratified UN-R79.

Configuration 16. In the vehicle control device in the above embodiment,

in a case where a traveling speed of the vehicle is equal to or lower than a predetermined speed (for example, 40 km/h), the control unit conducts the automated lane change, based on the setting of the travel distance needed for the automated lane change, instead of the setting of the duration needed for the automated lane change.

Accordingly, in the case of the automated lane change while the vehicle is traveling at a low speed, a sufficient travel distance cannot be ensured by determining with the duration, in some cases. However, even in such cases, an operation in compliance with the regulations related to the travel distance can be performed.

Configuration 17. An operation method of a vehicle control device in the above embodiment is an operation method of a vehicle control device (for example, 13) that controls a vehicle (for example, 1), the operation method including:

acquiring (for example, S104) surrounding information of the vehicle; and

controlling (for example, S102 to S109) to conduct an automated lane change, based on the surrounding information, in which

in the controlling, a setting of either a duration (for example, T1 to T3) needed for the automated lane change or a travel distance (for example, L1 to L3) needed for the automated lane change is changed, based on either an instruction from a user or position information of the vehicle at a time of conducting the automated lane change (for example, S102 to S103).

With this configuration, the user is able to freely change the setting related to the automated lane change or to change the setting related to the automated lane change in accordance with a geographical location of the vehicle. That is, it becomes easily possible to change the setting related to the automated lane change to an appropriate setting. Therefore, it becomes possible to easily change the setting to a setting in compliance with the laws and regulations related to the automated lane change that differs depending on the nation or the state, the compliance at the time of traveling can be improved, and the traffic safety can be improved. In addition, with one product specification, it becomes possible to comply with the laws and regulations in all nations or states, and thus the merchantability can be improved.

Configuration 18. A program in the above embodiments is a program for causing a computer to function as the vehicle control device of any of the configurations 1 to 16.

Accordingly, the processing of the vehicle control device can be realized by the computer.

According to the present invention, it becomes possible to easily change the setting related to the automated lane change to an appropriate setting, and traffic safety can be improved.

The invention is not limited to the foregoing embodiments, and various variations/changes are possible within the spirit of the invention.

What is claimed is:

1. A vehicle control device that controls a vehicle, the vehicle control device comprising:
an acquisition unit configured to acquire surrounding information of the vehicle; and
a control unit configured to conduct an automated lane change based on the surrounding information, wherein
the control unit changes a setting of either a duration needed for the automated lane change or a travel distance needed for the automated lane change, based on either an instruction from a user or position information of the vehicle at a time of conducting the automated lane change.

2. The vehicle control device according to claim 1, wherein an operation for the automated lane change includes a first operation of maintaining the vehicle in a traveling lane.

3. The vehicle control device according to claim 2, wherein the control unit changes a setting of either a duration needed for the first operation or a travel distance needed for the first operation.

4. The vehicle control device according to claim 2, wherein the operation for the automated lane change further includes a second operation of causing the vehicle to make a lateral movement until the vehicle reaches a division line between the traveling lane and an adjacent lane, after the first operation.

5. The vehicle control device according to claim 4, wherein the second operation is an operation from the vehicle starting the lateral movement to a reference position of the vehicle reaching the division line.

6. The vehicle control device according to claim 5, wherein the reference position is a front wheel position of the vehicle in a direction of the lateral movement.

7. The vehicle control device according to claim 4, wherein the control unit changes a setting of either a duration needed for the second operation or a travel distance needed for the second operation.

8. The vehicle control device according to claim 4, wherein the operation for the automated lane change further includes a third operation of causing the vehicle to travel across the division line and converge in the adjacent lane, after the second operation.

9. The vehicle control device according to claim 8, wherein the control unit changes a setting of either a duration needed for the third operation or a travel distance needed for the third operation.

10. The vehicle control device according to claim 1, further comprising a reception unit configured to receive the instruction from the user, wherein
the control unit changes the setting of either the duration or the travel distance, based on the instruction received by the reception unit.

11. The vehicle control device according to claim 10, wherein
a plurality of candidates are registered beforehand for the duration or the travel distance, and
the user selects any of the plurality of candidates, and the control unit changes the setting of either the duration or the travel distance.

12. The vehicle control device according to claim 1, further comprising a confirmation unit configured to prompt confirmation of a change in the setting, when the instruction from the user is received.

13. The vehicle control device according to claim 1, further comprising a position information acquisition unit configured to acquire the position information of the vehicle, wherein
when the vehicle moves into a different nation or state, based on the position information of the vehicle, the control unit changes the setting of either the duration or the travel distance to a setting in compliance with the different nation or state.

14. The vehicle control device according to claim 1, further comprising:
a position information acquisition unit configured to acquire the position information of the vehicle; and
a notification unit configured to notify a warning, in a case where the setting of either the duration or the travel distance is not appropriate for a nation, a state, or a province where the vehicle is traveling, based on the position information of the vehicle.

15. The vehicle control device according to claim 1, wherein
an operation for the automated lane change includes
a first operation of maintaining the vehicle in a traveling lane, and
a second operation of causing the vehicle to make a lateral movement until the vehicle reaches a division line between the traveling lane and an adjacent lane, after the first operation, and
the control unit
does not change, as a fixed value, a setting of either a duration needed for the first operation or a travel distance needed for the first operation, and
changes a setting of either a duration needed for the second operation or a travel distance needed for the second operation.

16. The vehicle control device according to claim 1, wherein in a case where a traveling speed of the vehicle is equal to or lower than a predetermined speed, the control unit conducts the automated lane change, based on the setting of the travel distance needed for the automated lane change, instead of the setting of the duration needed for the automated lane change.

17. An operation method of a vehicle control device that controls a vehicle, the operation method comprising:
acquiring surrounding information of the vehicle; and
controlling to conduct an automated lane change, based on the surrounding information, wherein
in the controlling, a setting of either a duration needed for the automated lane change or a travel distance needed for the automated lane change is changed, based on either an instruction from a user or position information of the vehicle at a time of conducting the automated lane change.

18. A non-transitory computer-readable storage medium for storing a program for causing a computer to execute an operation method of a vehicle control device that controls a vehicle, the operation method comprising:
acquiring surrounding information of the vehicle; and
controlling to conduct an automated lane change, based on the surrounding information, wherein
in the controlling, a setting of either a duration needed for the automated lane change or a travel distance needed for the automated lane change is changed, based on either an instruction from a user or position information of the vehicle at a time of conducting the automated lane change.
